(19) United States
(12) Patent Application Publication
(10) Pub. No.: US 2005/0157838 A1
(43) Pub. Date: Jul. 21, 2005

(54) Axially segregated part-length fuel rods in a reactor fuel bundle

(76) Inventors: Lukas Trosman, Wilmington, NC (US); Cary L. Kunz, Wilmington, NC (US); Russell E. Stachowski, Wilmington, NC (US); Russell M. Fawcett, Atkinson, NC (US); Shingo Fujimaki, Yokohama-Shi (JP); Daisuke Goto, Kamakura-shi (JP)

Correspondence Address: HARNESS, DICKEY & PIERCE, P.L.C., P.O. BOX 8910, RESTON, VA, 20195, US

(21) Appl. No.: 10/748,175

(22) Filed: Dec. 31, 2003

(51) Int. Cl. G21C 3/32

(52) U.S. Cl. 376/435

(57) ABSTRACT

A reactor fuel bundle includes a channel having an inner perimeter wall and a channel longitudinal centerline. Both full-length and part-length fuel rods are positioned within the channel. The part-length rods are separated into two groups. A first group has intermediate-length rods located immediately adjacent to the inner perimeter wall. A second group has short-length rods located approximate the channel longitudinal centerline.

### CROSS REFERENCE TO RELATED APPLICATIONS

This application addresses similar subject matter to co-pending and commonly assigned U.S. patent application Ser. No. (unassigned) filed concurrently herewith, entitled DISTRIBUTED CLUMPING OF PART-LENGTH RODS FOR A REACTOR FUEL BUNDLE, by the inventors of the subject application.

### BACKGROUND OF THE INVENTION

1. Field of the Invention

The present invention relates in general to fuel bundles and more specifically to an apparatus and method for disposing varying length fuel rods in a fuel channel assembly.

2. Related Art

Fuel bundles for boiling water reactors typically each provide a plurality of vertically stacked fuel rods. Common fuel bundles or fuel assemblies provide a square or rectangular shaped perimeter wall called a channel within which the fuel rods are positioned. Reactor coolant flowing through the boiling water reactor enters the bottom of the channel and passes vertically upward and longitudinally over the fuel rods where it is heated to form steam. The steam discharges from upper openings in the fuel bundle. Boiling water reactors may contain several hundred fuel bundles. One or more water passages are also commonly provided within each fuel bundle to maintain a source of water to slow down a sufficient quantity of neutrons to initiate and maintain reactor criticality.

The highest potential operating energy for a boiling water reactor is obtained if all fuel rods are full-length fuel rods. The disadvantage of using 100% full-length fuel rods is that reactor shut-down margin is not optimized. Following a reactor shut-down, fission does not immediately stop. Neutrons continue to fission, and it is necessary to trap sufficient neutrons to prevent inadvertent reactor criticality. Shut-down margin is therefore a sufficient percentage of trapped neutrons compared to fissioned neutrons which prevents criticality. Shut-down margin is commonly enhanced by distributing a quantity of part-length fuel rods in each fuel bundle. A vacant volume above each part-length fuel rod provides an additional water volume when the reactor is shut down. These additional water volumes trap neutrons to provide increased shut-down margin for the reactor.

Common fuel bundle group all of the part-length rods adjacent to the interior fluid passage(s). Several common designs distribute part-length fuel rods in single lengths, within an outer ring of full-length fuel rods. It is also known to distribute two lengths of part-length fuel rods, having short-length fuel rods positioned in each corner of the channel body, and intermediate-length fuel rods arranged generally about the interior water passage(s).

The known configurations of part-length fuel rods in a fuel bundle therefore do not achieve optimum reactor critical power and/or shut-down margin.

### SUMMARY OF THE INVENTION

The present invention provides a fuel bundle including a channel having an inner perimeter wall and a channel longitudinal centerline. A plurality of fuel rods having both full-length rods and part-length rods are positioned within the channel. The part-length rods are separable into two groups. A first group has intermediate-length rods disposed immediately adjacent to the inner perimeter wall. A second group has short-length rods, shorter than the intermediate-length rods, disposed adjacent to a channel longitudinal centerline.

The use of part-length fuel rods improves shut-down margin. Separating the part-length rods into two groups retains overall fuel mass while distributing fuel less uniformly throughout the fuel bundle. The outer periphery of the fuel bundle is the most desirable location to position full-length fuel rods. By locating the intermediate-length rods immediately adjacent to the inner perimeter wall and the short-length rods toward the inner region of the channel body, shut-down margin is improved by flattening a cold axial neutron flux peak, without removing excessive fuel from the desirable outer periphery of the fuel bundle.

Locating intermediate-length fuel rods immediately adjacent to the inner perimeter wall locally provides a water volume during shutdown conditions. This provides for increased capture (i.e., trapping) of neutrons to improve shut-down margin. This local water volume is further increased in an exemplary embodiment by grouping the intermediate-length fuel rods in pairs. The detrimental effect of fuel loss in this desirable fuel location is reduced by removing less than half of the fuel from a full-length fuel rod to form each intermediate-length fuel rod.

To retain the overall mass of fuel while providing sufficient void volume for shut-down water traps, the greatest fuel reduction area (and therefore the greatest void volume to form water traps) is shifted to the channel inner region by positioning the short-length fuel rods therein. To prevent steam-venting, the length of both the intermediate-length fuel rods and the short-length fuel rods can be optimized over a range of lengths.

Further areas of applicability of the present invention will become apparent from the detailed description provided hereinafter. It should be understood that the detailed description and specific examples, while indicating several exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a partial sectioned elevation view of a fuel bundle of the present invention;

FIG. 2 is a sectional view taken at Section 2-2 of FIG. 1 identifying a preferred embodiment for the part-length rods of the present invention;

FIG. 3 is sectional view taken at Section 3-3 of FIG. 1 identifying the void regions about the water passages and above the location of the short-length rods of the present invention;

FIG. 4 is a sectional view taken at Section 4-4 of FIG. 1 identifying both the voids above the short-length rods and the intermediate-length rods of the present invention and the overall water trap areas formed thereby; and

FIG. 5 is a sectional view similar to FIG. 2 showing another embodiment having an odd-numbered configuration of fuel rods in a row-and-column configuration.

### DETAILED DESCRIPTION

The following description of the preferred embodiment(s) is merely exemplary in nature and is in no way intended to limit the invention, its application, or uses.

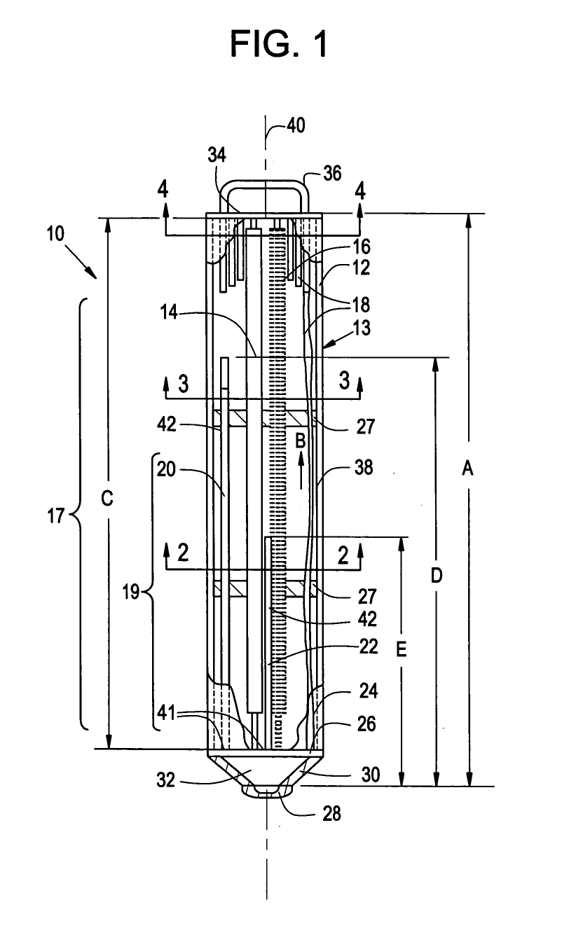

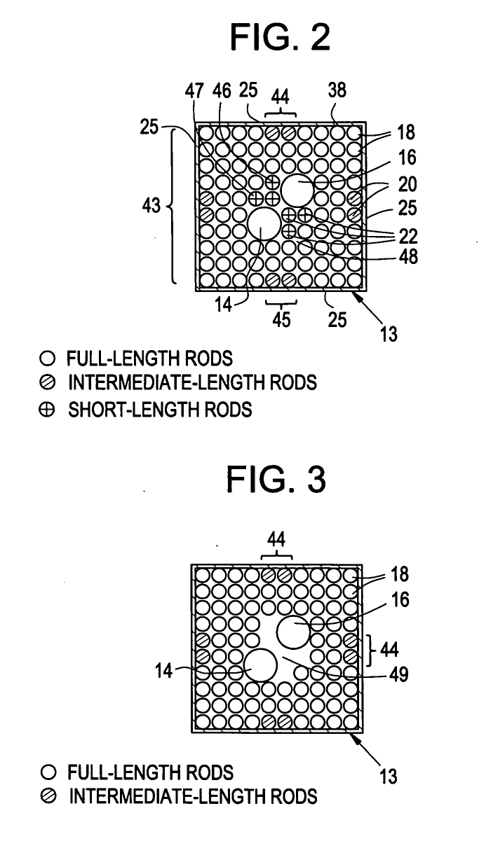

Referring to FIG. 1, a fuel bundle 10 of the present invention is shown. The fuel bundle 10 includes a channel 12, generally formed as a square-shaped tube 13 (best seen in reference to FIGS. 2-4), having a first water passage 14 and a second water passage 16 each disposed throughout a total length A of the channel 12. A plurality of fuel rods 17 includes a plurality of full-length fuel rods 18 and a plurality of part-length fuel rods 19. The plurality of part-length fuel rods 19 is further divisible into a plurality of intermediate-length fuel-rods 20, and a plurality of short-length fuel rods 22. Full-length fuel rods 18 are partially shown in the upper area of the fuel bundle 10. The lower portions of the full-length fuel rods 18 are not shown for clarity. For clarity, only an exemplary one of the plurality of intermediate-length fuel-rods 20 and an exemplary one of the plurality of short-length fuel rods 22 are shown disposed within the channel 12. A perimeter wall 24, having approximately equal length sides 25 (best seen in reference to FIG. 2), encompasses each of the fuel rods and the first and second water passages 14 and 16, respectively.

Each fuel rod 17 and water passage 14, 16 is supported as necessary by a lower support 26 connectably attached to the channel 12. At least one horizontal support member 27 is provided as necessary to support the fuel rods and the water passages. A lower channel end 28 supports the fuel bundle 10 in a boiling water reactor vessel (not shown). Reactor coolant flowing through the boiling water reactor encounters an inlet surface 30 provided with an inlet aperture 32 disposed adjacent to the lower channel end 28. The reactor coolant enters the aperture 32 and flows vertically upward within the channel 12 in a channel flow direction B as shown. Reactor coolant is heated to form steam by contacting and longitudinally traversing each of the fuel rods of the fuel bundle 10. The steam discharges from an upper channel end 34 of the channel 12. A lifting member 36 is connectably attached to the upper channel end 34 to provide a mechanical lift point to install or remove each fuel bundle 10 from its location in a boiling water reactor.

Each of the fuel rods disposed within the channel 12 are arranged in a generally parallel configuration with each other fuel rod and with the first water passage 14 and the second water passage 16, respectively. The fuel rods are disposed such that they do not contact an inner perimeter wall 38 of the channel 12. In the embodiment shown, the first water passage 14 and the second water passage 16 are disposed adjacent to a channel longitudinal centerline 40. Each full-length fuel rod 18 has a length C. The intermediate-length fuel rods 20 have a length D, which is less than the length of full-length fuel rods 18, but greater than 50% of the length of the full-length fuel rods 20. The short-length fuel rods 22 have a length E, which is less than the length of the intermediate-length fuel rods 20. As shown, the length C is less than 50% the length of the full-length fuel rods 18.

The fuel channel assembly illustrated in FIG. 1 is but one example of a plurality of possible fuel bundle designs. For example, the first water passage 14 and the second water passage 16 can be replaced by a single water passage (not shown) generally centrally disposed about or adjacent to the longitudinal centerline 40. Each of the first water passage 14 and the second water passage 16 are shown having generally tubular shape, however, the invention is not limited to the geometry of the water passage shape. Alternate water passage shapes can be used including rectangular, oval, square, cruciform shapes and free-flowing (i.e., having no perimeter walls) water passage shapes. Namely, a free-form water passage is defined as a longitudinal void amongst the fuel rods.

The first water passage 14, the second water passage 16, each of the full-length fuel rods 18, each of the intermediate-lengths fuel rods 20, and each of the short-length fuel rods 22 are generally connected to the lower support 26 at each of a rod lower support end 41, which provides vertical support for these components. The one or more horizontal support members 27 are preferably spaced near a distal end 42 of either the short-length fuel rods 22 or the intermediate-length fuel rods 20, to provide vertical support for each of the fuel rods and the water passages (having perimeter walls) within the channel 12. A plurality of designs are known for the horizontal support members 27, and each can vary depending on the quantity of fuel rods and/or water passages supported.

As best seen in FIGS. 2-4, an exemplary configuration of fuel rods including full-length fuel rods 18, intermediate-length fuel rods 20, and short-length fuel rods 22 are shown for an exemplary embodiment of the present invention. The fuel rods are disposed in a row-and-column configuration 43 having generally equivalent spacing between each adjacent pair of fuel rods. A portion of the total fuel rods in each fuel bundle 10 are removed to provide for the water passages (e.g. the first water passage 14, and the second water passage 16). In the embodiment shown, each of the intermediate-length fuel rods 20 are installed as a first group 44. The first group 44 has intermediate-length fuel rods 20 grouped in pairs 45. Each of the pairs 45 of intermediate-length fuel rods 20 are located approximately mid-span along each inner perimeter wall 38. The row-and-column configuration 43 of the fuel rods is shown as a 10×10 configuration. It will be appreciated that a plurality of row-and-column configurations, including 8×8, 9×9, and other configurations of fuel rods can be used without departing from scope of the present invention.

The intermediate-length fuel rods 20 each preferably have a nominal length D of approximately 66% of the length C of any one of the full-length fuel rods 18. Each intermediate-length fuel rod 20 may range in length from approximately 60% to approximately 90% of the length C of any one of the full-length fuel rods 18. By positioning the intermediate-length fuel rods 20 immediately adjacent to an inner perimeter wall 38, a majority of the fuel normally disposed in a full-length fuel rod 18 is conserved in this outer perimeter of the fuel bundle 10.

Each of the short-length fuel rods 22 are arranged in a second group 46, second group 46 disposed generally inward from the inner perimeter wall 38. The second group 46 of short-length fuel rods 22 are further arranged into each of a rod subgroup 47 and a rod subgroup 48, each including an exemplary three short-length fuel rods 22. The rod subgroup 47 and the rod subgroup 48 are arranged in mirror image about the first water passage 14 and the second water passage 16, respectively. Each short-length fuel rod 22 preferably has a nominal length E of approximately 33% of the total length C of any one of the full-length fuel rods 18. The short-length fuel rods 22 may range in length between approximately 10% to approximately 40% of the length C of any one of the full-length fuel rods 18.

In an exemplary embodiment, a total fuel volume of the combined intermediate-length fuel rods 20 and the short-length fuel rods 22 is retained. This requires that an increase in the length of the intermediate-length fuel rods 20 be accompanied by a proportionate decrease in the length of the short-length fuel rods 22 and vice-versa.

Referring next to FIG. 3, a section view looking upward and above the elevation of the short-length fuel rods 22 shows each of a plurality of voids 49. During a shut-down condition of the reactor, the voids 49 fill with water to form water traps which trap neutrons and improve the shutdown margin for the boiling water reactor. The first group 44 of intermediate-length fuel rods 20 are present at this elevation within the channel 12 and therefore do not contribute to the voids 49.

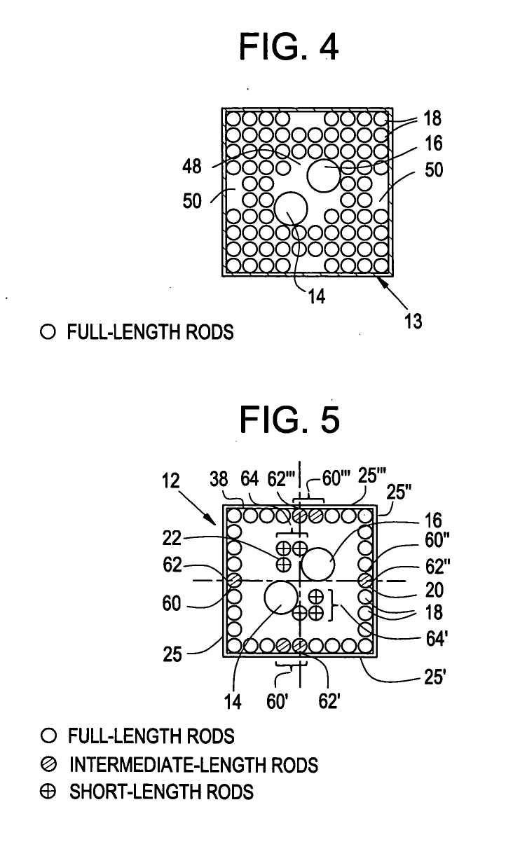

As best seen in FIG. 4, a section view looking upward above both the intermediate-length fuel rods 20 and the short-length fuel rods 22 is shown. In addition to the voids 49 above the short-length fuel rods 22, a plurality of voids 50 are formed above each of the intermediate-length fuel rods 20. A combination of the voids 49 and the voids 50 provide a distributed volume of water in the fuel bundle 10 during a shut-down condition of the reactor, which absorbs neutrons and improves a shutdown margin for the boiling water reactor.

As shown in FIG. 5, an alternate embodiment of the present invention provides an exemplary odd number (i.e., nine) of fuel rods, including full-length fuel rods 18 and intermediate-length fuel rods 20, positioned adjacent the inner perimeter wall 38 of channel 12, and short-length fuel rods 22 positioned approximate the first and second water passages 14, 16 respectively. Only selected fuel rods are shown in FIG. 5 for discussion purposes. The intermediate-length fuel rods 20 are arranged in four rod subsets 60, 60′, 60″, 60′″, each having at least one intermediate-length fuel rod 20 positioned adjacent to a mid-span point 62, 62′, 62″, 62′″, respectively, of the inner perimeter wall 38. The single (i.e., non-paired) intermediate-length fuel rods 20 can also be located (not shown) on any two adjacent sides (e.g., 25, 25′) of channel 12 instead of on opposite sides 25, 25″ as shown in FIG. 5. The short length fuel rods 22 are arranged in two short length fuel rod subgroups 64 and 64′, respectively, both disposed in mirror image about the water passages 14 and 16. Each of the short length fuel rod subgroups 64 and 64′ include an exemplary three short length fuel rods 22. The quantity of short length fuel rods 22 in each subgroup can vary from that shown, depending on the overall quantity and arrangement of fuel rods in channel 12.

The fuel bundle 10 of the present invention offers several advantages. By grouping the part-length fuel rods by length, as well as selectively positioning each group in the fuel bundle 10, an increased shut-down margin is provided. By disposing intermediate-length fuel rods 20 immediately adjacent to an inner perimeter wall of the channel, less fuel is removed from the perimeter of each fuel bundle. By controlling the length of the short-length fuel rods 22 of the present invention and optimizing their length with that of the intermediate-length fuel rods 20, steam-venting through the fuel bundle 10 may be prevented in an arrangement that provides increased water volume for water traps during a reactor shut-down condition. By dividing the part-length fuel rods into two lengths of fuel rods, the mass of fuel is retained while permitting a distribution of power through the fuel bundle 10. The power is distributed over the length of the channel more efficiently and a peak power is distributed over a broader length of the fuel bundle. Improved efficiency results from the distribution of power. Power distribution over the length of fuel rods (i.e., the length of the bundle) is also more evenly distributed using a combination of the short-length and intermediate-length fuel rods of the present invention compared to fuel rod arrangements known in the art.

The description of the invention is merely exemplary in nature and, thus, variations that do not depart from the gist of the invention are intended to be within the scope of the invention. Such variations are not to be regarded as a departure from the spirit and scope of the invention.

1. A reactor fuel bundle, comprising:
a channel having at least one inner perimeter wall and a channel longitudinal centerline;
at least one support member in contact with said channel;
a plurality of fuel rods including both full-length rods and part-length rods each fixedly connectable to said support member and spatially separable from each other by said support member; and
said part-length rods being divisible into two groups including:
a first group having intermediate-length rods each disposed proximate to said inner perimeter wall; and
a second group having short-length rods divisible into two rod sub-groups, each sub-group having three short-length fuel rods arranged in a triangular shape, each of said short-length rods being shorter than said intermediate-length rods;
wherein both said two rod sub-groups are disposed proximate to said channel longitudinal centerline.

2. The fuel bundle of claim 2, wherein said channel comprises a square-shaped tube having opposed open ends and equal-length sides.

3. The fuel bundle of claim 3, wherein said fuel rods are disposed in a row-and-column configuration in said square-shaped tube, having equal spacing between proximate ones of said fuel rods.

4. The fuel bundle of claim 2, wherein said intermediate-length rods further comprise four rod pairs, each said pair disposed substantially mid-span proximate one of said equal length sides.

5. The fuel bundle of claim 1, wherein said channel includes at least one water passage defining a tube fixedly connected to said support member and Positioned longitudinally between said opposed open ends in said channel and substantially parallel to said channel longitudinal centerline.

6. The fuel bundle of claim 1, comprising:
said channel includes a pair of water passages each defining a tube fixedly connected to said support member and Positioned longitudinally between said opposed open ends in said channel and proximate to said channel longitudinal centerline; and
said two rod subgroups each disposed approximate proximate both to each other and said pair of water passages.

7. The fuel bundle of claim 1, wherein:
said at least one support member further includes both a lower support member fixedly connected to said at least one inner perimeter wall and operable to fixedly support said plurality of fuel rods, and a plurality of horizontal support members;
said plurality of fuel rods each having a lower support end and a distal end, said fuel rods each fixedly connected at said lower support end to said lower support member; and
said plurality of fuel rods being supported from said channel substantially at each said fuel rod distal end by one of an upper channel end fixedly connected to the channel and a at least one of said plurality of horizontal support members fixedly connected to at least said fuel rods.

8. A reactor fuel bundle providing enhanced reactor shut-down margin, comprising:
a channel having a first end, a second end, and four rectangular configured perimeter walls;
a plurality of fuel rods longitudinally disposed within said channel;
a plurality of support members in contact with said perimeter walls and operable to fixedly support said fuel rods;
said fuel rods being divisible into a plurality of full-length fuel rods generally distributed in said channel, a plurality of intermediate-length fuel rods outwardly disposed in said channel and each proximately positioned to one of said perimeter walls, and a plurality of short-length fuel rods disposed in said channel inward of said intermediate-length fuel rods, said short-length fuel rods being divisible into two rod sub-groups, each sub-group having three short-length fuel rods arranged in a triangular shape each of said short-length rods being shorter than said intermediate-length rods;
a plurality of voids defined between a second end of said channel and a distal end of each of said intermediate-length and short-length fuel rods; and
a connecting end of both said intermediate-length fuel rods and said short-length fuel rods being fixedly connected to one of said support members positioned at said first end of said channel.

9. The fuel bundle of claim 8, wherein said intermediate-length fuel rods further comprise a plurality of rod sub-groups each having at least one intermediate-length fuel rod per sub-group.

10. The fuel bundle of claim 9, wherein said sub-groups each comprise pairs of intermediate-length fuel rods.

11. (canceled)

12. The fuel bundle of claim 44 10, wherein each said pair of intermediate-length fuel rods has each said intermediate-length fuel rod disposed proximate to a mid-span of said one of said perimeter walls.

13. The fuel bundle of claim 8, wherein said plurality of fuel rods are disposed in a row-and-column configuration within said four perimeter walls.

14. The fuel bundle of claim 10, wherein each said intermediate-length fuel rod comprises a length ranging from substantially 60 percent to substantially 90 percent of a length of one of said full-length fuel rods.

15. The fuel bundle of claim 10, wherein each said intermediate-length fuel rod comprises a length substantially 66 percent of a length of one of said full-length fuel rods.

16. The fuel bundle of claim 10, wherein each said short-length fuel rod comprises a length ranging between substantially 10 percent to substantially 40 percent of a length of one of said full-length fuel rods.

17. The fuel bundle of claim 10, wherein each said short-length fuel rod comprises a length substantially 33 percent of a length of a one of said full-length fuel rods.

18. A reactor fuel bundle, comprising:
a channel having four contiguous inner perimeter walls and a channel longitudinal centerline;
a plurality of fuel rods including both full-length fuel rods and part-length fuel rods;
said part-length fuel rods being separable into two groups including,
a first group having intermediate-length fuel rods disposed immediately adjacent to one of said inner perimeter walls; and
a second group having short-length fuel rods disposed approximate to said channel longitudinal centerline; and
an odd number of said fuel rods disposed adjacent to each of said inner perimeter walls.

19. The fuel bundle of claim 18, wherein said intermediate-length fuel rods further comprise four rod subsets, each said subset having at least one intermediate-length fuel rod disposed at an approximate mid-span point along one of said inner perimeter walls.

20. The fuel bundle of claim 18, wherein said second group of short-length fuel rods further comprises two subgroups each having at least one short-length fuel rod disposed immediately adjacent to one of a pair of water passages defined in the channel.
